(19) United States
(12) Patent Application Publication
(10) Pub. No.: US 2017/0136655 A1
(43) Pub. Date: May 18, 2017

(54) WIRE CUTTING DEVICE COMPRISING A ROTARY MEMBER PROVIDED WITH MEANS FOR LUBRICATION OF THE WIRE

(71) Applicant: COMMISSARIAT À L'ÉNERGIE ATOMIQUE ET AUX ÉNERGIES ALTERNATIVES, Paris (FR)

(72) Inventors: Pedro JERONIMO, La Cote Saint-Andre (FR); Fabrice COUSTIER, Barberaz (FR); Mathieu DEBOURDEAU, Saint Pierre D'Allevard (FR)

(73) Assignee: COMMISSARIAT À L'ÉNERGIE ATOMIQUE ET AUX ÉNERGIES ALTERNATIVES, Paris (FR)

(21) Appl. No.: 15/320,178

(22) PCT Filed: Jun. 22, 2015
(86) PCT No.: PCT/EP2015/063928

§ 371 Date: Dec. 19, 2016

(30) Foreign Application Priority Data
Jun. 23, 2014 (FR) 14 55790

(51) Int. Cl. B28D 5/04; B23D 57/00; B28D 5/00

(52) U.S. Cl. CPC B28D 5/045; B28D 5/0076; B23D 57/0053

(57) ABSTRACT

A device for cutting a wire piece, configured to move with respect to the wire piece, including: at least first and second rotary members rotating around respective first and second substantially parallel axes of rotation, the at least one first and second rotary members driving the wire substantially perpendicular to the first and second axes, the wire resting against external surfaces of each of the at least one first and second rotary members. At least one of the at least one first and second rotary members includes a lubrication mechanism of the wire to allow circulation of a lubricating liquid from the center thereof to an external surface thereof in contact with the wire, the lubrication mechanism including a lubrication liquid feed device, mounted on the axis of rotation of the at least one of the first and second rotary members, to supply the center thereof with lubrication liquid.

### TECHNICAL FIELD

This invention relates to the general field of devices for wire cutting or sawing, and more particularly to the field of means for lubricating such devices.

The invention has for example applications in the industry of electronic components, ferrites, quartz and/or silicas, for example for the obtaining of thin slices (more generally referred to as “wafers”) of materials such as crystalline silicon, used in particular for the manufacture of photovoltaic cells, sapphire or silicon carbide. It can also be used in the framework of cropping bricks of materials such as silicon, or for the cutting of the bottom of ingots, for example of size G5 (840×840 mm in depth), of size G6 (1040×1040 mm in depth), or more.

The invention as such proposes a device for wire cutting comprising at least one rotary member provided with means for lubricating the wire, as well as an associated method for wire cutting.

### PRIOR ART

Known devices for wire cutting most often comprise a wire, or plus generally a web of wires, able to be displaced according to a continuous or alternating movement bearing against a piece to be cut into one or several wafers as such defining a cutting zone. The cutting zone can be comprised of a set of cylinders placed in parallel. These cylinders called “wire guide” can be etched with grooves that define the interval between the wires of the web, in other words the thickness of the wafers to be cut. The piece to be cut is fastened on a support table that is displaced perpendicularly to the wire. The speed of displacement defines the cutting speed. The renewing of the wire, as well as the control of the tension, are carried out in a portion that defines a management zone of the wire, located outside of the cutting zone per se. The agent that will govern the cutting is for example an abrasive fastened onto the wire, or a free abrasive conveyed via bubbling. The wire acts only as a transporter.

The wire used, even if it acts only as a transporter, undergoes a certain wear over time and its proper operation in order to carry out the cutting of the piece requires substantial lubrication, generally with water, that is constant on the wire.

Systems for lubricating devices for wire cutting known in prior art most often use nozzles for lubrication (or for spraying). These lubrication nozzles can be fixed or mobile, and will spray a lubricating liquid onto the wire during the cutting.

However, the use of such nozzles is not entirely satisfactory and has several disadvantages.

First of all, through the importance of the lubrication of the wire to be provided, the positioning of the nozzles is often carried out as close as possible to the wire. However, in the case where an arrow begins to appear on the wire, due for example to its wear or a piece to be cut with high hardness, there is a high probability that the nozzles will be cut by the wire. Inversely, when the nozzles are positioned in separated fashion with respect to the wire, there is a high probability of having lubrication that is not constant during the cutting.

Moreover, devices for wire cutting are most of the time provided with a spraying via the top of the wire onto a very short section. However, in light of the high speeds of the running of the wire, it is generally not guaranteed to ensure that a film of lubricating liquid indeed be constantly present around the wire. Therefore, the wire can become dirty over time.

Furthermore, due to flow rate limitation constraints, the use of a reduced number of nozzles is generally preferred, often limited to the use of a single nozzle. However, when this nozzle becomes clogged, this then results in the stoppage of the lubrication and therefore premature wear of the wire.

### DESCRIPTION OF THE INVENTION

Consequently, there is a need to propose an alternative solution in order to allow for the lubrication of the wire of a device for wire cutting. There is in particular a need to design a solution for the lubrication of the wire that is of high reliability and that makes it possible to guarantee a constant lubrication during the cutting.

The invention has for purpose to overcome at least partially the needs mentioned hereinabove and the disadvantages concerning the embodiments of prior art.

It aims in particular to propose such a solution in order to facilitate the lubrication and the cutting of large-size pieces, having a large surface area and therefore requiring a substantial consumption of wire.

The invention also has for object, according to one of its aspects, a device for wire cutting a piece to be cut, intended to move with respect to the wire to enable the cut, comprising at least one first rotary member rotating around a first axis of rotation and one second rotary member about a second axis of rotation, said first and second axes of rotation being substantially parallel to one another, said at least one first and one second rotary members driving the wire substantially perpendicular to said first and second axes of rotation, the wire resting against the external surface of each one of said at least one first and one second rotary members extending about the corresponding axis of rotation, characterised in that at least one of said at least one first and one second rotary members comprises means for lubricating the wire configured to allow circulation of a lubricating liquid from the centre thereof to the external surface thereof in contact with the wire.

The term “wire” means either a single wire, or a web of wires substantially parallel to each other, with the choice depending on the type of wire cutting device.

Thanks to the invention, it can be possible to prevent, or at least limit, the aforementioned disadvantages linked to the use of nozzles for the lubrication of wires of devices for wire cutting. The invention can in particular allow for a better lubrication of the wire of a device for wire cutting, and in particular of large-size pieces to be cut.

The wire cutting device according to the invention can further comprise one or several of the following characteristics taken separately or according to any technically permissible combination.

The lubricating liquid is advantageously water, even polyethylene glycol (PEG).

The lubrication means can comprise a lubrication liquid feed device, mounted on the axis of rotation of said at least one of said at least one first and one second rotary members, to supply the centre thereof with lubrication liquid.

The lubrication liquid feed device can comprise a valve for regulating the flow rate of lubricating liquid injected at the centre of said at least one of said at least one first and one second rotary members.

Advantageously, the presence of such a valve for regulating the flow rate, in particular in the form of a solenoid valve, can make it possible to control at any time the consumption of the wire cutting device with lubricating liquid. It can also be possible to cut the piece by using a control of the lubrication of the wire according to the engine torque associated with the rotary member and/or the arrows of the wire, for example.

In addition, the presence of the valve for regulating the flow rate can also make it possible to improve the surface condition of the cut piece, by directly controlling the flow rate of the lubricating liquid.

Moreover, said one at least of said at least one first and one second rotary members can comprise a pulley provided with a groove on the external surface thereof in order to allow for the positioning and the driving of the wire.

According to an embodiment, the lubrication means can be at least partially formed by at least one internal channel of the pulley for the circulation of the lubricating liquid from the centre of the pulley to the external surface of the pulley.

Said at least one internal channel can in particular extend from the centre of the pulley and open into an internal annular channel allowing for the circulation of the lubricating liquid to the external surface of the pulley.

Furthermore, the internal annular channel can be delimited at least partially by an internal surface of the pulley, opposite the external surface. The internal surface can be pierced by a plurality of passage orifices in order to convey the lubricating liquid from the internal annular channel to the groove of the pulley in contact with the wire.

The lubrication means can also be at least partially formed by four internal channels of the pulley for the circulation of the lubricating liquid from the centre of the pulley to the external surface of the pulley.

The four internal channels can have, as observation from the front, a shape of a cross, comprising in particular four branches curved according to the same direction of orientation.

According to another embodiment, the lubrication means can be are partially formed by an internal distribution element of the lubricating liquid from the centre to the external surface of the pulley, with this internal distribution element being without movement and configured to act as a pendulum, the internal distribution element being furthermore able to receive the lubricating liquid from the centre of the pulley and extending partially about the axis of rotation of said at least one of said at least one first and one second rotary members in such a way as to define an angular portion for the distribution of the lubricating liquid for the circulation to the external surface of the pulley.

The internal distribution element can for example extend at least over three-quarters of a turn about the axis of rotation of the rotary member.

The internal distribution element can be hollow in such a way as to receive the lubricating liquid.

The internal distribution element can comprise an anti-gravity system in order to allow for the immobility thereof with respect to the rest of the pulley.

The internal distribution element can be mounted on a ball bearing axis.

Moreover, the pulley can comprise a rotating portion delimited by the external surface of the pulley and by an internal surface, opposite the external surface, and extending all about the internal distribution element, with the rotating portion comprising a plurality of passage orifices for conveying the lubricating liquid sprayed by the angular portion for the distribution from the internal distribution element to the groove of the pulley in contact with the wire.

Furthermore, for each embodiment of the device according to the invention, the first rotary member can comprise first means for lubricating the wire configured to allow circulation of a lubricating liquid from the centre to the external surface of the first rotary member in contact with the wire, and the second rotary member can comprise second means for lubricating the wire configured to allow circulation of a lubricating liquid from the centre to the external surface of the second rotary member in contact with the wire.

Moreover, according to other embodiments according to the invention, said at least one of said at least one first and one second rotary members can comprise a hollow cylinder forming a “wire guide” of which the external surface is provided in order to allow for the positioning and the driving of the wire.

As such, according to an embodiment, the hollow cylinder can in particular be supplied at the centre thereof with lubrication liquid, and the lubrication means can be at least partially formed by a plurality of passage orifices pierced in the wall of the hollow cylinder in order to allow for the circulation of the lubricating liquid from the centre to the external surface of the hollow cylinder.

Moreover, according to another embodiment, the hollow cylinder can be in particular supplied at the centre thereof with lubrication liquid, and the lubrication means can be at least partially formed by a plurality of distribution slots, made in the wall of the hollow cylinder over the length thereof, with the distribution slots allowing the circulation of the lubricating liquid from the centre to the external surface of the hollow cylinder.

The hollow cylinder can further comprise an end plate at at least one of the ends thereof, comprising an edge formed by a plurality of protruding elements, intended to be engaged in the distribution slots between longitudinal portions of the wall of the hollow cylinder in such a way as to allow for an accumulation of the lubricating liquid in the distribution slots.

For each one of the embodiments according to the invention, the device can moreover comprise first, second, third and fourth rotary members respectively about the first, second, third and fourth axes of rotation, with the axes of rotation being substantially parallel to one another, with the rotary members driving the wire substantially perpendicular to the axes of rotation, the wire resting against the external surface of each one of the rotary members extending about the corresponding axis of rotation, with the first, second, third and fourth rotary members respectively comprising first, second, third and fourth means for lubricating the wire configured to allow for the circulation of the lubricating liquid from their centre to their external surface in contact with the wire.

Furthermore, the invention further has for object, according to another of its aspects, a method for wire cutting a piece to be cut, characterised in that it is implemented by means of a device for wire cutting such as defined hereinabove, and in that it comprises the step of lubricating the wire by the intermediary of the lubrication means of at least one rotary member.

The method can particularly comprise the step consisting in adapting the value of the operating parameters of the wire cutting device according to the progression of the wire inside the piece to be cut during the cutting.

Such parameters can for example preferentially comprise the speed of rotation and the torque of the engine driving the lubrication liquid feed device of the rotary member, the arrow of the cutting wire, even also the flow rate of the lubricating liquid, the position of the wire all along the cutting, measured for example using a detection sensor, or the speed of displacement of the cutting device with respect to the support whereon the piece to be cut is placed.

The wire cutting device and the method according to the invention can comprise any of the characteristics mentioned in the description, taken separately or according to any technically permissible combination with other characteristics.

### BRIEF DESCRIPTION OF THE DRAWINGS

The invention can be better understood when reading the following detailed description, non-limiting examples of implementing the latter, as well as when examining the figures, diagrammatical and partial, of the annexed drawing, wherein:

FIG. 1 shows, according to a partial perspective view, a first example of a wire cutting device in accordance with the invention,

FIG. 2 is an exploded view in perspective of a rotary member of the wire cutting device of FIG. 1,

FIG. 3 shows, as a front view, the pulley of the rotary member of FIG. 2,

FIG. 4 is a cross-section view in perspective of the pulley of FIG. 3,

FIG. 5 shows, according to a partial perspective view, a rotary member of a second example of a wire cutting device in accordance with the invention,

FIG. 6 shows, according to a partially exploded perspective view, a rotary member of a third example of a wire cutting device in accordance with the invention,

FIG. 7 shows, in perspective, the plate of the rotary member of FIG. 6,

FIG. 8 shows, in perspective, a detail of the rotary member of FIG. 6 after assembly of the plate of FIG. 7,

FIG. 9 shows, in perspective, the third example of a wire cutting device in accordance with the invention comprising the rotary member of FIG. 6,

FIG. 10 shows, in perspective, a rotary member of a fourth example of a wire cutting device in accordance with the invention,

FIG. 11 shows a partial detail of FIG. 10,

FIG. 12 shows, in perspective, a configuration of the positioning of a piece to be cut using a device for wire cutting in accordance with the invention, positioned on a support,

FIG. 13 shows, in the form of a diagram, an example of an implementation of the method for wire cutting in accordance with the invention, and

FIGS. 14A, 14B and 14C respectively show three examples of methods of controlling implemented in a method for wire cutting in accordance with the invention.

In all of these figures, identical references can designate identical or similar elements.

In addition, the different portions shown in the figures are not necessarily shown according to a uniform scale, in order to render the figures more legible.

### DETAILED DESCRIPTION OF PARTICULAR EMBODIMENT

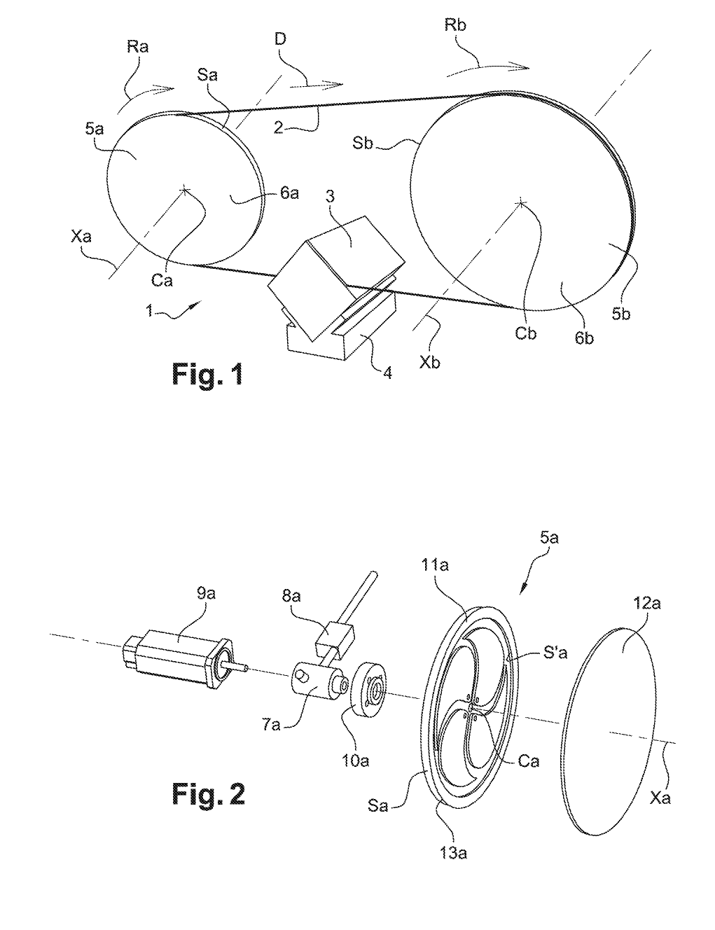

In reference to FIGS. 1 to 4, a first example of device 1 for wire cutting 2 in accordance with the invention was first of all shown.

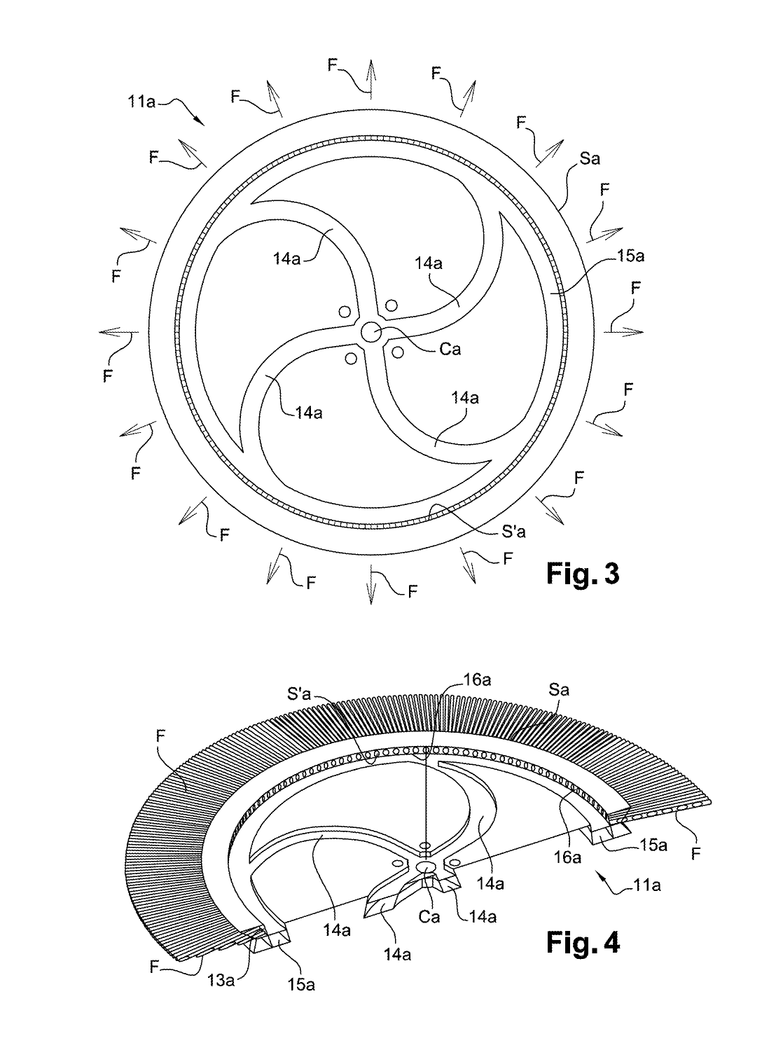

More precisely, FIG. 1 is a partial perspective view of the device 1, FIG. 2 is an exploded view in perspective of a rotary member 5a of the device 1, FIG. 3 is a front view of the pulley 11a of the rotary member 5a, and FIG. 4 is a cross-section perspective view of the pulley 11a.

The device 1 for wire cutting 2 is used to allow for the cutting of a piece to be cut 3, for example made from a material such as crystalline silicon, used for example for the manufacturing of photovoltaic cells, as indicated hereinabove. The piece to be cut 3 is carried by a support 4 and set into motion with respect to the wire 2 to enable the cut.

The device 1 comprises a first rotary member 5a rotating around a first axis of rotation Xa and one second rotary member 5b about a second axis of rotation Xb. The first 5a and second 5b rotary members rotate respectively according to the same directions of rotation Ra and Rb, for example in the clockwise direction in FIG. 1, in such a way as to allow for the displacement of the wire 2 according to the direction D.

The first Xa and second Xb axes of rotation are moreover substantially parallel to each other. In this way, the first 5a and second 5b rotary members allow for the driving of the wire 2 substantially perpendicular to the first Xa and second Xb axes of rotation.

In addition, during the driving thereof, the wire 2 is bearing against the external surface Sa of the first rotary member 5a and against the external surface Sb of the second rotary member 5b, with the external surface Sa extending about the first axis of rotation Xa, and the external surface Sb extending about the second axes of rotation Xb.

Moreover, in accordance with the invention, the first 5a and a second 5b rotary members respectively comprise lubrication means 6a and 6b of the wire 2 which are configured to allow circulation of a lubricating liquid F, in particular of the water or of the polyethylene glycol (PEG), from the centre thereof Ca or Cb to the external surface thereof Sa or Sb in contact with the wire 2.

As such, advantageously, the lubrication with water or with PEG of the wire 2 is clearly facilitated and improved, as such increasing the service life of the wire 2 and the effectiveness of the cutting of the piece 3.

In reference to FIG. 2, the lubrication means 6a of the rotary member 5a are described more precisely. The lubrication means 6a as such comprise a lubrication liquid (F) feed device 7a or rotating joint 7a, which is mounted on the axis of rotation Xa of the first rotary member 5a in order to feed the centre thereof Ca with lubricating liquid F.

The rotating joint 7a is driven in rotation by the intermediary of an engine 9a with which it is integral.

Moreover, the rotating joint 7a comprises a valve for regulating 8a the flow rate of the lubricating liquid F injected into the centre Ca of the first rotary member 5a, preferentially in the form of a solenoid valve 8a. The solenoid valve 8a advantageously makes it possible to control at any time the consumption of the device 1 in lubricating liquid F. It can as such be possible to cut the piece 3 by using a controlling of the lubrication of the wire 2 according to the engine torque associated with the rotary member 5a and/or with the arrow of the wire 2 and/or with the speed of rotation of the engine, for example. In addition, the presence of the solenoid valve 8a can also make it possible to improve the surface condition of the cut piece 3, by directly controlling the flow rate of the lubricating liquid F.

In addition, as can be seen in FIGS. 2 to 4, the first rotary member 5a comprises a pulley 11a provided with a groove 13a on the external surface thereof Sa in order to allow for the positioning and the driving of the wire 2. The lubrication of the wire 2 is as such carried out directly via this drive pulley 11, and no longer through the use of nozzles as according to prior art described hereinabove. The pulley 11a is carried out in such a way as to allow for the flow of the lubricating liquid F inside the latter, from the centre thereof Ca to the external surface thereof Sa, as described hereinafter.

A ball bearing casing 10a is furthermore provided between the rotating joint 7a and the pulley 11a, in such a way that the lubricating liquid F injected into the device 1 circulates from the solenoid valve 8a, to the rotating joint 7a, then the casing 10a before finally reaching the pulley 11a.

A plate 12a is moreover provided to cover and close the pulley 11a in such a way as to maintain the flow of the lubricating liquid F inside of the pulley 11a.

As can be seen in FIG. 3, within the pulley 11a, the lubrication means 6a are at least partially formed by several internal channels 14a of the pulley 11a for the circulation of the lubricating liquid F from the centre Ca of the pulley 11a to the external surface Sa of the pulley 11a. The number of internal channels 14a is equal to 4 in the example of FIG. 3. However, a different number of channels can be considered, for example starting from 2, 3 or 8 channels.

Each internal channel 14a extends from the centre Ca of the pulley 11a and opens into an internal annular channel 15a that allows for the circulation of the lubricating liquid F to the external surface Sa of the pulley 11a. In FIG. 3, the arrows F symbolise the flow of the lubricating liquid F beyond the external surface Sa of the pulley 11a in order to lubricate the wire 2.

The four internal channels 14a moreover have, as observation from the front as according to FIG. 3, a shape of a cross comprising four branches curved according to the same direction of orientation, for example the anti-clockwise direction. This specific shape of the internal channels 14a can in particular make it possible to obtain a spraying of the lubricating liquid F from the centre Ca to the external surface Sa that is at high speed.

In addition, the internal annular channel 15a is delimited by the internal surface S′a of the pulley 11a, opposite the external surface Sa. This internal surface S′a is pierced with a plurality of passage orifices 16a, as can be seen in FIG. 4, in order to convey the lubricating liquid F from the internal annular channel 15a to the groove 13a of the pulley 11a in contact with the wire 2. In this FIG. 4, the references F represent the drops of lubricating liquid F escaping from the passage orifices 16a. The passage orifices 16a can for example be pierced on the internal surface S′a at regular intervals, for example every millimetre.

The invention can also be applied to devices 1 for wire cutting 2 in the form of diamond wire saws for example.

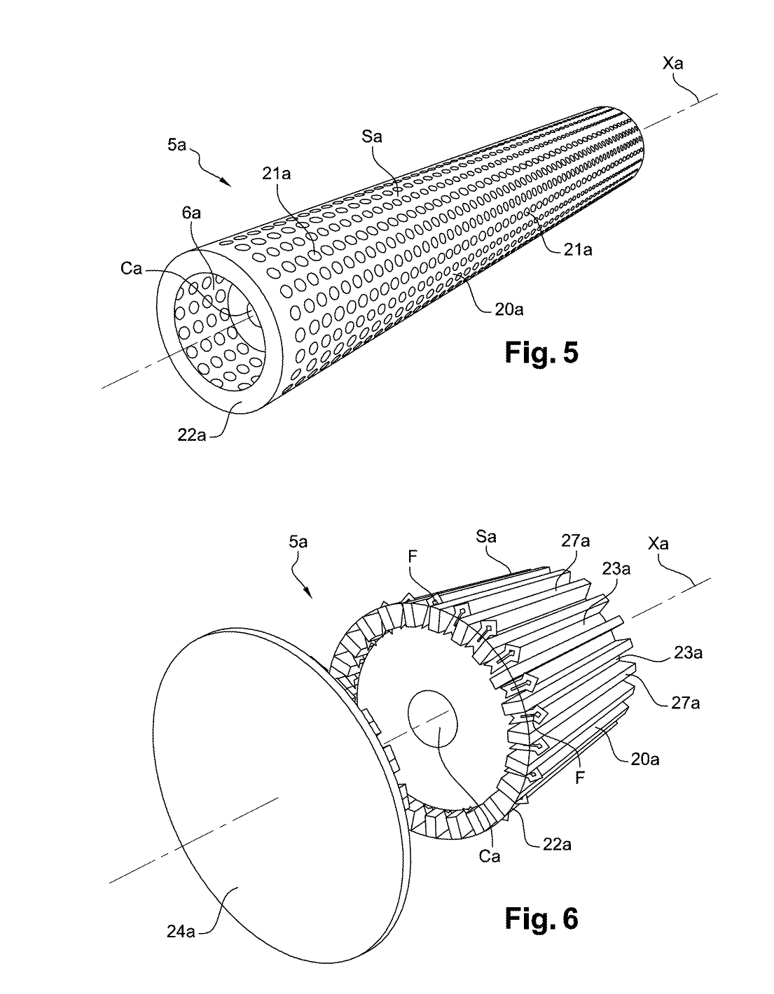

FIG. 5 as such shows, according to a partial perspective view, a rotary member 5a of second example of a device 1 for wire cutting 2 in accordance with the invention.

In this example, the rotary member 5a comprises a hollow cylinder 20a that forms a “wire guide” of which the external surface Sa is designed to allow for the positioning and the driving of the wire 2.

This hollow cylinder 20a is fed from the inside at the centre thereof Ca by lubricating liquid F. The lubrication means 6a are formed by a plurality of passage orifices 21a pierced in the wall 22a of the hollow cylinder 20a, and in its possible covering made of polyurethane, in order to allow for the circulation of the lubricating liquid F from the centre Ca to the external surface Sa of the hollow cylinder 20a, in other words for conveying the lubricating liquid F to underneath the wire 2 and not above, or of the web of wires 2. This solution can possibly make it possible to prevent chips of silicon from sticking to the wire 2.

It has moreover been shown in reference to FIGS. 6 to 9 a third embodiment of a device 1 for wire cutting 2 in accordance with the invention.

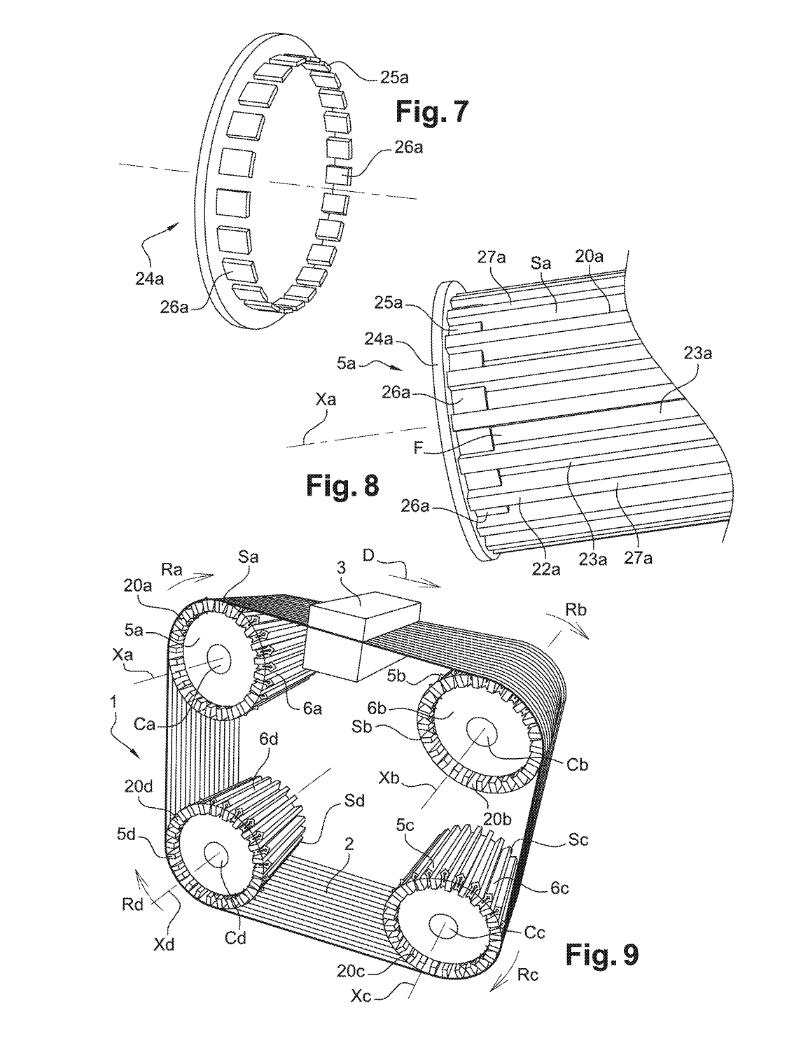

More precisely, FIG. 6 is a partially exploded perspective view of a first rotary member 5a of this embodiment, FIG. 7 shows, in perspective, the plate 24a of the rotary member 5a, FIG. 8 shows, in perspective, a detail of the rotary member 5a after the assembly of the plate 24a, and FIG. 9 shows, in perspective, the device 1 of this embodiment comprising four rotary members 5a to 5d.

In this example also, the rotary member 5a comprises a hollow cylinder 20a forming a “wire guide” of which the external surface Sa is provided to allow for the positioning and the driving of the wire 2.

Moreover, this hollow cylinder 20a is fed at its centre Ca with lubricating liquid F. The lubrication means 6a are here formed by a plurality of distribution slots 23a, made in the wall 22a of the hollow cylinder 20a over the length thereof, with the distribution slots 23a allowing for the circulation of the lubricating liquid F from the centre Ca to the external surface Sa of the hollow cylinder 20a.

The supplying with lubricating liquid F can be carried out from the standard equipment of a diamond wire saw. The distribution slots 23a allow for the accumulation of the lubricating liquid F and its spraying onto the web of wires 2 from underneath rather than from above. In this way, this can possibly make it possible to prevent chips of silicon from sticking to the wire 2.

Furthermore, as can be seen in FIGS. 6, 7 and 8, the hollow cylinder 20a comprises an end plate 24a at its two ends. This end plate 24a comprises an edge 25a formed by a plurality of protruding elements 26a, intended to engage in the distribution slots 23a between longitudinal portions 27a of the wall 22a of the hollow cylinder 20a. In this way, the accumulation of the lubricating liquid F in the distribution slots 23a is made possible. The lubricating liquid F propagates more specifically in the distribution slots 23a and under the edge 25a of the end plate 24a, as shown in FIG. 8.

Finally, the device 1 for wire cutting 2 according to this example is shown in a general manner in FIG. 9.

It as such comprises first 5a, second 5b, third 5c and fourth 5d rotary members, similar to the one described in FIGS. 6, 7 and 8, respectively about the first Xa, second Xb, third Xc and fourth Xd axes of rotation, with these axes of rotation being substantially parallel to one another.

The rotary members 5a, 5b, 5c and 5d allow for the driving of the wire 2 substantially perpendicularly to the axes of rotation Xa, Xb, Xc and Xd, the wire 2 resting against the external surface Sa, Sb, Sc and Sd of each one of the rotary members 5a, 5b, 5c and 5d. In addition, the first 5a, second 5b, third 5c and fourth 5d rotary members respectively comprise first 6a, second 6b, third 6c and fourth 6d means for lubricating the wire 2, similar to those described hereinabove, as such configured to allow for the circulation of the lubricating liquid F from the centre thereof Ca, Cb, Cc and Cd to the external surface thereof Sa, Sb, Sc and Sd in contact with the wire 2.

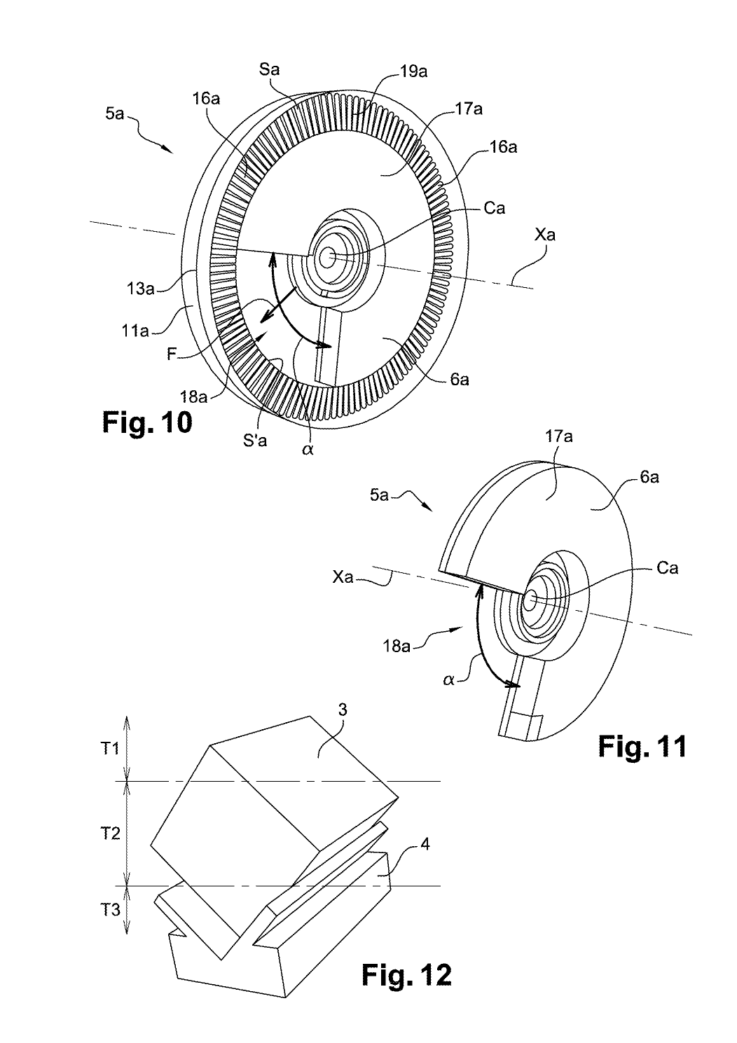

It has moreover been shown in reference to FIGS. 10 and 11 a fourth embodiment according to the invention.

More precisely, FIG. 10 shows, in perspective, a first rotary member 5a of this example, and FIG. 11 shows a partial detail of FIG. 10.

This fourth example is as such based on the use of a mechanical system located inside the pulley 11a and which acts as a pendulum. This system, in particular due to its design and the centre of gravity thereof, is not in movement contrary to the pulley 11a.

More precisely, in this example, the lubrication means 6a are formed by an internal distribution element 17a of the lubricating liquid F from the centre Ca to the external surface Sa of the pulley 11a, with this internal distribution element 17a as such being without movement and configured to act as a pendulum.

The internal distribution element 17a is able to receive the lubricating liquid F from the centre Ca of the pulley 11a and extends partially about the axis of rotation Xa of the first rotary member 5a in such a way as to define an angular portion for the distribution 18a of angle α of the lubricating liquid F for the circulation to the external surface Sa of the pulley 11a.

This internal distribution element 17a is for example mounted on a bearing. It can extend at least over a three-quarter turn about the axis of rotation Xa of the rotary member 5a. In this way, the angle α of the angular portion for the distribution 18a is for example about 90°. This angular portion for the distribution 18a defines the portion of the pulley 11a which is “sprayed” by the lubricating liquid F at the outlet of the internal distribution element 17a. By referring to the arrangement of the rotary members 5a and 5b of FIG. 1, the internal distribution element 17a can as such make it possible to lubricate only the portion of the wire 2 that enters into the material of the piece 3 for the rotary member 5a located to the left, and to lubricate only the portion of the wire 2 that exits from the material of the piece 3 for the rotary member Sb located to the right.

The internal distribution element 17a is preferentially hollow in such a way as to receive the lubricating liquid F. It furthermore comprises an anti-gravity system in order to allow for the immobility thereof with respect to the rest of the pulley 11a.

Furthermore, the pulley 11a comprises a rotating portion 19a delimited by the external surface Sa of the pulley 11a and by an internal surface S′a, opposite the external surface Sa, and extending all about the internal distribution element 17a.

The rotating portion 19a comprises a plurality of passage orifices 16a for conveying the lubricating liquid F sprayed by the angular portion for the distribution 18a of the internal distribution element 17a to the groove 13a of the pulley 11a in contact with the wire 2.

Thanks to this fourth embodiment, it can be possible to carry out a lubrication of the wire 2 that is precise and directed. Such a device 1 can also make it possible to reduce the consumption of lubricating liquid F, in particular of water or PEG.

Examples of implementations of the method according to the invention for wire cutting 2 a piece to be cut 3 shall now be described in reference to FIGS. 12, 13 and 14A to 14C.

FIG. 12 shows, in perspective, a configuration of the positioning of the piece to be cut 3 using a device 1 for wire cutting 2 in accordance with the invention, positioned on a support 4.

In this FIG. 12, the references T1, T2 and T3 respectively show the first upper third, the second intermediate third and the third lower third of the piece 3.

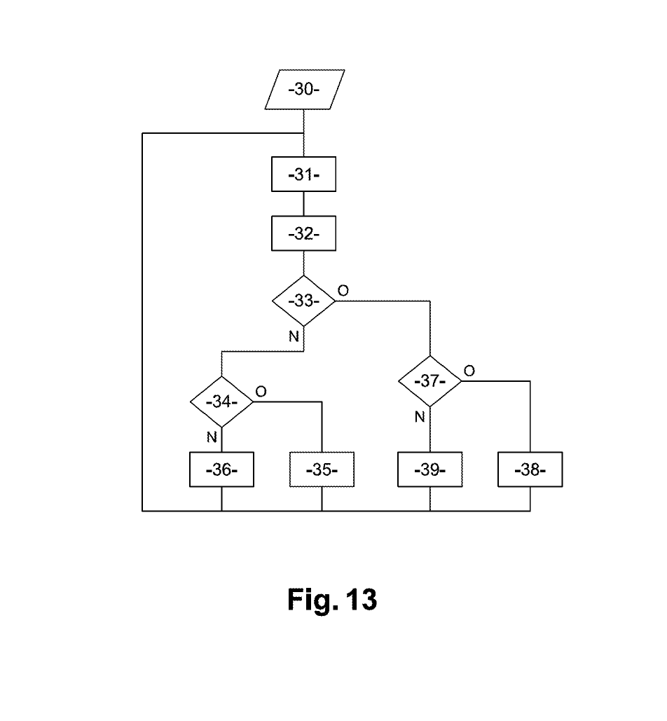

FIG. 13 shows, in the form of a diagram, an example of steps of implementing a method in accordance with the invention.

Such a method can for example allow for the management of the operation of the device 1 by adaptation of the value of the operating parameters of the device 1 according to the progression of the wire 2 inside the piece to be cut 3 during the cutting.

The operating parameters, which come into account for the management of the device 1, can for example comprise: the speed of rotation Vm of the engine 9a driving the lubricating liquid F feed device 7a of the rotary member 5a, the torque Cm of the engine 9a, the flow rate Db of the lubricating liquid F, the arrow of the cutting wire 2, or the speed of displacement Vd of the cutting device 1 with respect to the support 4 whereon the piece to be cut 3 is placed.

As such, in FIG. 13, the step 30 marks the starting step of the method of management of the operation of the device 1. In the step 31, the device 1 and the support 4 are positioned with respect to one another then, in the step 32, an engine torque Cm is applied.

During the step 33, interest is given to the positioning of the wire 2 in the second third T2 of the piece 3, as shown in FIG. 12.

Then, if the wire 2 is positioned in this second third T2 of the piece 3, step 37 is reached. During the latter, interest is given to knowing if the value of the engine torque Cm is greater than a predetermined limit value Lim. If such is the case, the flow rate Db of the lubricating liquid F is increased and the speed of displacement Vd is decreased during the step 38. On the contrary, if the engine torque Cm is less than the predetermined limit value Lim, the flow rate Db of the lubricating liquid F is decreased and speed of displacement Vd is increased during the step 39, with the speed of rotation Vm of the engine remaining identical.

Moreover, if in the step 33, the wire 2 is not positioned in the second third T2 of the piece 3 as shown in FIG. 12, interest is then given, during the step 34, to knowing if the value of the engine torque Cm is greater than the predetermined limit value Lim indicated hereinabove. If such is the case, the flow rate Db as well as the speed of rotation Vm of the engine will be increased during the step 35. On the contrary, if the value of the engine torque Cm is less than the predetermined limit value Lim, the flow rate Db as well as the speed of rotation Vm of the engine are decreased during the step 36, with the speed of displacement Vd of the cutting device 1 with respect to the support 4 remaining unchanged.

At the end of the steps 34, 36, 38 or 39, the method resumes from step 31, as shown in FIG. 13.

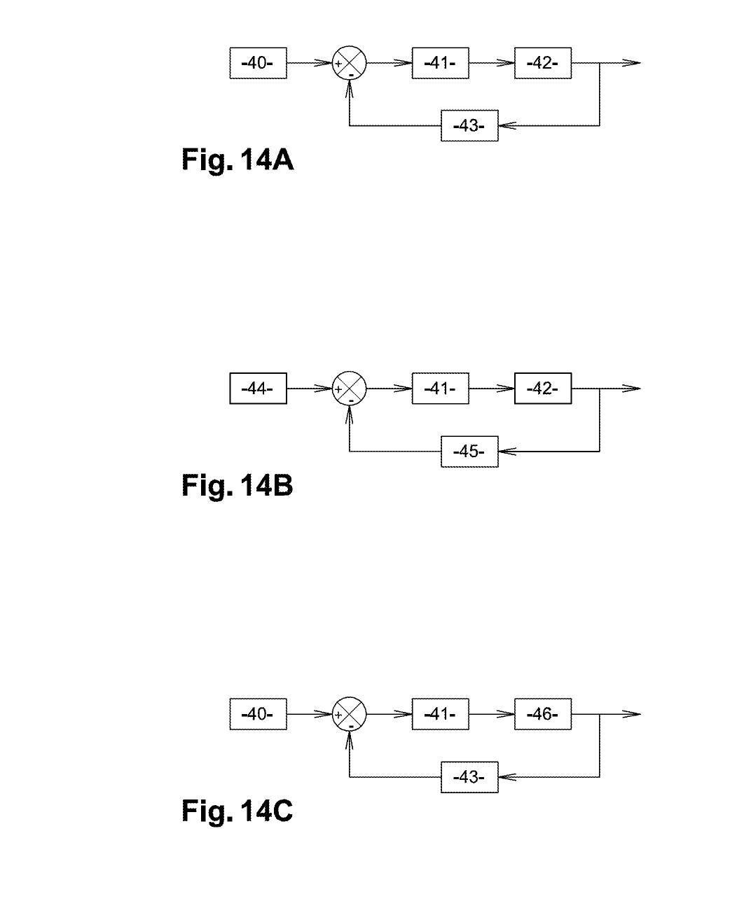

Finally, FIGS. 14A, 14B and 14C respectively show three examples of methods of controlling implemented in the method for wire cutting 2 in accordance with the invention.

In FIG. 14A, a set point value on the engine torque Cm is given in 40. The controlling is then implemented between the speed of rotation Vm in 41 of the engine in 42 and the engine torque Cm in 43.

In FIG. 14B, a set point value on the positioning of the wire 2 is given in 44. The controlling is then implemented between the speed of rotation Vm in 41 of the engine in 42 and the position of the wire 2 in 45.

Finally, in FIG. 14C, a set point value on the engine torque Cm is given in 40. The controlling is then implemented between the speed of rotation in 41 of the engine of the cutting head in 46 and the engine torque Cm in 43. The engine of the cutting head provides the displacement of the cutting head in translation.

Of course, the invention is not limited to the embodiments that have just been described. Various modifications can be made therein by those skilled in the art.

In particular, in the embodiments considered and described hereinabove, the rotary members 5a, Sb, 5c and 5d have a section of circular shape.

Alternatively, at least two rotary members could be of asymmetrical shape. More precisely, the perimeter of the external surface of at least two rotary members could as such have any type of shape that is not substantially circular in such a way that at least two points of the perimeter are located at different distances from the axis (or from the centre) of rotation of said at least two rotary members.

For example, such a shape in section of said at least two rotary members could be substantially polygonal, for example rectangular, square, triangular, or more preferentially substantially oval.

Advantageously, this would make it possible to improve the surface condition of the material of the piece to be cut and to increase the capacity of removing material.

The expression “comprising one” must be understood as being synonymous with “comprising at least one”, unless mentioned otherwise.

1-16. (canceled)

17. A device for wire cutting of a piece to be cut, configured to move with respect to the wire to enable a cut, comprising:
at least one first rotary member rotating around a first axis of rotation and one second rotary member about a second axis of rotation, the first and second axes of rotation being substantially parallel to one another, the at least one first and one second rotary members driving the wire substantially perpendicular to the first and second axes of rotation, the wire resting against an external surface of each of the at least one first and one second rotary members extending around the corresponding axis of rotation,
wherein at least one of the at least one first and one second rotary members comprises lubrication means of the wire configured to allow circulation of a lubricating liquid from the center thereof to the external surface thereof in contact with the wire, and
wherein the lubrication means comprises a lubricating liquid feed device, mounted on the axis of rotation of the at least one of the at least one first and one second rotary members, to feed the center thereof with lubricating liquid.

18. A device according to claim 17, wherein the lubricating liquid feed device comprises a valve for regulating a flow rate of the lubricating liquid injected into the center of the at least one of the at least one first and one second rotary members.

19. A device according to claim 17, wherein the at least one of the at least one first and one second rotary members comprises a pulley including a groove on the external surface thereof to allow for positioning and driving of the wire.

20. A device according to claim 19, wherein the lubrication means is at least partially formed by at least one internal channel of the pulley for circulation of the lubricating liquid from the center of the pulley to an external surface of the pulley.

21. a device according to claim 20, wherein the at least one internal channel extends from the center of the pulley and opens into an internal annular channel that allows for the circulation of the lubricating liquid to the external surface of the pulley.

22. A device according to claim 21, wherein the internal annular channel is delimited at least partially by an internal surface of the pulley, opposite the external surface, and wherein the internal surface is pierced by a plurality of passage orifices to convey the lubricating liquid from the internal annular channel to the groove of the pulley in contact with the wire.

23. A device according to claim 19, wherein the lubrication means is at least partially formed by an internal distribution element of the lubricating liquid from the center to the external surface of the pulley, with the internal distribution element being without movement and configured to act as a pendulum, with the internal distribution element configured to receive the lubricating liquid from the center of the pulley and extending partially about the axis of rotation of the at least one of the at least one first and one second rotary members to define an angular portion for the distribution of the lubricating liquid for the circulation to the external surface of the pulley.

24. A device according to claim 23, wherein the pulley comprises a rotating portion delimited by the external surface of the pulley and by an internal surface, opposite the external surface, and extending all around the internal distribution element, with the rotating portion comprising a plurality of passage orifices to convey the lubricating liquid sprayed by the angular portion for the distribution of the internal distribution element to the groove of the pulley in contact with the wire.

25. A device as claimed in claim 17, wherein the first rotary member comprises first lubrication means of the wire configured to allow circulation of a lubricating liquid from the center to the external surface of the first rotary member in contact with the wire, and wherein the second rotary member comprises second lubrication means of the wire configured to allow circulation of a lubricating liquid from the center to the external surface of the second rotary member in contact with the wire.

26. A device according to claim 17, wherein the at least one of the at least one first and one second rotary members comprises a hollow cylinder forming a wire guide with an external surface to allow for positioning and driving of the wire.

27. A device according to claim 26, wherein the hollow cylinder is fed at the center thereof by lubricating liquid, and wherein the lubrication means is at least partially formed by a plurality of passage orifices pierced in a wall of the hollow cylinder to allow for circulation of the lubricating liquid from the center to the external surface of the hollow cylinder.

28. A device according to claim 26, wherein the hollow cylinder is fed at its center with lubricating liquid, and wherein the lubrication means is at least partially formed by a plurality of distribution slots, made in a wall of the hollow cylinder over the length thereof, with the distribution slots allowing for circulation of the lubricating liquid from the center to the external surface of the hollow cylinder.

29. A device according to claim 28, wherein the hollow cylinder comprises an end plates at least one of the ends thereof comprising an edge formed by a plurality of protruding elements, configured to engage in the distribution slots between longitudinal portions of the wall of the hollow cylinder to allow for an accumulation of the lubricating liquid in the distribution slots.

30. A device according to claim 26, comprising first, second, third, and fourth rotary members respectively about first, second, third, and fourth axes of rotation, with the axes of rotation being substantially parallel to one another, with the rotary members driving the wire substantially perpendicular to the axes of rotation, the wire resting against an external surface of each one of the rotary members extending about the corresponding axis of rotation, with the first, second, third, and fourth rotary members comprising respectively first, second, third, and fourth means for lubricating the wire configured to allow for circulation of the lubricating liquid from the center thereof to the external surface thereof in contact with the wire.

31. A method for wire cutting of a piece to be cut, implemented by a device for wire cutting as claimed in claim 17, and comprising lubricating the wire by an intermediary of the lubrication means of at least one rotary member.

32. A method according to claim 31, further comprising adapting values of operating parameters of the device for wire cutting according to progression of the wire inside the piece to be cut during cutting.
